(19) United States
(12) Patent Application Publication
(10) Pub. No.: US 2007/0159354 A1
(43) Pub. Date: Jul. 12, 2007

(54) INTELLIGENT EMERGENCY VEHICLE ALERT SYSTEM AND USER INTERFACE

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/610,499

(22) Filed: Dec. 13, 2006

Related U.S. Application Data
(60) Provisional application No. 60/757,825, filed on Jan. 9, 2006.

(51) Int. Cl. G08G 1/00

(52) U.S. Cl. 340/902

(57) ABSTRACT

An intelligent emergency vehicle alert system includes a locative server in communication with processors of each of an emergency vehicle and a ground vehicle. The locative server repeatedly receives locative data from each of the emergency vehicle and the ground vehicle. The locative data indicates a substantially current geospatial location of the respective vehicle. An intelligent emergency vehicle alerting process is also provided. The process is operative to selectively alert a driver of the ground vehicle of a presence of the emergency vehicle. The alert is conveyed at least in part based upon a determined spatial proximity between the emergency vehicle and the ground vehicle. The alert may also be based upon a determination that the emergency vehicle and ground vehicle are traveling on the same road of travel, in the same direction of travel, and/or that the emergency vehicle is behind the ground vehicle

### RELATED APPLICATION DATA

This application claims priority to provisional application Ser. No. 60/757,825, filed Jan. 9, 2006, the disclosure of which is hereby incorporated by reference herein in its entirety.

### FIELD OF THE APPLICATION

The present invention relates generally to an intelligent emergency vehicle alert system an associated method that informs a driver of a ground vehicle about the presence of a responding emergency vehicle in the local vicinity and indicates whether evasive action is required by the driver.

### BACKGROUND

Emergency vehicles such as ambulances, fire engines, and police cars often need to respond quickly to emergency calls, making their way through traffic as urgently as they can. An emergency vehicle that is moving urgently through traffic in the service of an emergency call is referred to herein as Responding Emergency Vehicle or “REV”. At the present time when a responding emergency vehicle needs to travel through traffic, going down a road and/or crossing an intersection, it uses lights and sirens to warn nearby vehicles of its approach and to instruct vehicles that are in its way to move to the right and clear a path. While lights and sirens do warn other drivers of an approaching REV and instructs those drivers to clear a path, many drivers who need to be alerted about an approaching emergency vehicle fail to see the lights or hear the siren. Additionally, because lights and sirens are a non-specific means of information transfer, many drivers of vehicles that are not in the path of the responding emergency vehicle will see the lights and/or hear the sirens and take evasive action for no reason. This may cause extra traffic and/or unsafe driving conditions on roads and/or lanes that need not be affected.

Ultimately, lights and sirens are not a perfectly effective means of warning drivers about the presence of a REV that needs to pass. This is because the flashing lights of an emergency vehicle are not easily seen by drivers at distances, especially when the emergency vehicle is approaching from the rear, and/or when the flashing lights are used in daylight situations. The sirens are better at informing drivers at a distance, but sirens are difficult to place spatially and often cause confusion. Thus a driver may know that a responding emergency vehicle is near, but the driver may be unable to clearly determine how near the vehicle is and/or if the sound if the sound is coming from behind or from some other direction. Thus drivers often do not know if they need to slow and move to the right, or if the emergency vehicle is on a different road, traveling in a different direction, is up ahead, or is approaching from the side in a manner that might cause an intersection collision. This often causes drivers to take actions in response to hearing a siren that are unnecessary. To make matters worse, a driver of a vehicle who is playing his or her stereo may not hear the sirens until the emergency vehicle is too near to take effective action. Finally there are many situations in which a plurality of emergency vehicles is present on or near a particular road location, for example a plurality of REVs heading to the same emergency call, possibly from different directions. This can be highly confusing for drivers because it is often difficult for a driver to discern the presence of multiple emergency vehicles from flashing lights and/or an audible siren. In fact, a driver may easily slow to let an emergency vehicle pass only to resume driving and block a subsequent emergency vehicle because the driver believes he or she is only hearing one siren.

The current problems with the lights and siren approach to warning drivers about the presence of an REV that needs to pass results in numerous consequences. As mentioned above, drivers are often confused by lights and sirens and either (a) fail to take action when an REV needs to pass and thereby slow the REV's progress towards an emergency or (b) take action when an REV does not need to pass and unnecessarily slow traffic or cause dangerous driving conditions for no reason. As a consequence, REV response time is not as fast as it could be if drivers of other vehicles were more specifically and clearly alerted as to the presence of an REV vehicle that needs to pass. Even worse, emergency vehicles often end up in collisions with vehicles that fail to yield at intersections. By some estimates there are as many as 12,000 collisions annually of emergency vehicles (using lights and sirens) with other vehicles in the United States and Canada. In a study of just New York City and just ambulance REVs, more than 1400 collisions were documented in a 48-month period, resulting in almost 1900 injuries and six fatalities.

There is therefore a substantial need for an improved warning system for emergency vehicles such as ambulances, police cars, and fire trucks. A number of systems have been developed that enable information from one vehicle to be communicated to other vehicles. For example, a system disclosed in U.S. Pat. No. 6,801,837, the disclosure of which is hereby incorporated by reference, enables data about current driving conditions detected by one vehicle to be communicated to another vehicle that is in close proximity. Similarly, a prototype system developed by DaimlerChrysler entitled “CarTALK” enables vehicles equipped with wireless radio data communication systems to assemble themselves into ad-hoc networks and exchange information. These short distance connections are spontaneously created between the vehicles without the need for external infrastructure and can be used, for example, to inform one vehicle about the braking of other vehicles in the vicinity to trigger automatic safety feature. Other systems have been created for detecting traffic conditions by collecting data from a plurality of vehicles. For example, a system disclosed in U.S. Pat. No. 6,401,027, the disclosure of which is hereby incorporated by reference, enables a traffic monitoring system by collects data from a plurality of vehicles. Although such systems allow vehicles to exchange information about road conditions and/or gain information about traffic conditions, such systems do not address the unique warning needs of responding emergency vehicles. For example, current systems do not provide for an improved warning system for emergency vehicles that are approaching other vehicles from behind and/or from an alternate direction on intersecting road. In addition, the systems of the current art do not provide the ability to selectively alert vehicles as to the presence of an REV, alerting vehicles that need to take action without confusing and/or unnecessarily alerting other vehicles in a similar vicinity that do not need to take action.

As described in U.S. Pat. No. 5,359,527, the disclosure of which is hereby incorporated by reference, vehicle navigation systems are often incorporated in current automobiles and provide the driver with a route from a present position of a vehicle to a planned destination by displaying the route on a map-like display. Such systems often include destination decision processing software that derives a plurality of candidate destinations from map data stored in memory according to a general destination input by an operator, and displays the candidates on the display. Such systems also often include route search processing software that searches a route from the present position to one of the candidates that has been selected by the operator, and displays the searched route on the display. As disclosed in U.S. Pat. No. 5,442,557, the disclosure of which is also hereby incorporated by reference, vehicle navigation systems typically use a positioning system such as GPS along with a store of geographic map information as well as other information such as the location of landmarks. Although vehicle navigation systems are effective at tracking a vehicle's current location and displaying road map information to the driver relating to that vehicles current location and/or the driver's current destination, vehicle navigation systems of the present art do not provide alert information related to the presence of REVs that need to pass. Moreover, current navigation systems to not inform users as to whether or not action is required related to a nearby REV.

There is a navigation system in the current art that alerts drivers to moving obstacles and is disclosed in U.S. Pat. No. 6,411,896, the disclosure of which is hereby incorporated by reference. This disclosed system, however, relies entirely upon proximity of the moving obstacles and provides no means for identifying an emergency vehicle that is responding to a call and determining if that REV requires clearance for passage. Furthermore, the disclosure does not provide means for a driver to be selectively alerted to the presence of the REV, not based only upon proximity, but also based upon the vehicle being in the path of travel of the REV. Intelligent alerting is critical for providing a system that is superior to a simple light and siren approach. A light and siren approach is a proximity-based alerting method. An intelligent alerting method is needed that considers more than raw proximity and thereby more selectively alerts vehicles that need to take action with respect to an REV. What is also needed are improved user interface methods that help to alert drivers that may have loud music playing in their car or might be otherwise unaware of the presence of lights and sirens in their vicinity. Finally what is needed is a means by which a driver who may see or hear lights and sirens can receive supplemental information that indicates if action is required to clear a path for an approaching REV.

### SUMMARY

Embodiments of the present invention provide an intelligent emergency vehicle alert system that informs a driver of a ground vehicle about the presence of a responding emergency vehicle (“REV”) in the local vicinity and indicates whether evasive action is required by the driver to allow the REV to pass and/or to avoid a collision with the REV. Embodiments of the present invention inform the driver of a ground vehicle about the REV based upon the proximity of the REV to the ground vehicle and by considering additional factors that affect whether or not evasive action may be required of the driver of that ground vehicle. These additional factors include one or more of the road of travel of the REV, the road of travel of the ground vehicle, the direction of travel and/or orientation of the REV, the direction of travel and/or orientation of the ground vehicle, a forward/aft determination of the REV with respect to the ground vehicle, an intersecting paths determination of the ground vehicle with respect to the REV, and a road size and/or lane configuration determination of the road of travel of the REV. By using such additional factors, embodiments of the present invention may determine, for example, whether a ground vehicle is on the same road as the REV, is traveling in the same direction as the REV, is located ahead of the REV in the direction of travel of the REV, and is within a certain proximity of the REV. If all of these conditions are met, the driver of the ground vehicle is alerted by a system of the present invention to take evasive action. For example, the driver of the ground vehicle may be informed by a user interface to slow and pull to the right and thereby allow the REV to pass. On the other hand, if a ground vehicle is on the same road as the REV and within certain proximity of the REV but is traveling in the opposite direction of travel as the REV, the ground vehicle may not be alerted to take evasive action if the road of travel is determined to be of a large enough size and/or of sufficient lane configuration to enable passage of the REV without opposing traffic being halted. Similarly, if a ground vehicle is within close proximity of the REV but on a different road of travel that does not intersect the REV's road of travel, the ground vehicle may not be alerted to take evasive action. Thus, embodiments of the present invention provide for intelligent and selective alerting of ground vehicles with respect to REVs, and additional factors beyond raw proximity are considered when determining whether a ground vehicle should be alerted and/or whether a ground vehicle should be instructed to take evasive action with respect to the REV.

Embodiments of the present invention also provide for innovative user interface methods and an apparatus for alerting a driver as to the presence of an REV and/or for informing a driver to take evasive action. In some embodiments, a graphical display is used to indicate the presence of the REV. In some of such embodiments the graphical display includes an indication as to the relative location of the REV with respect to the driver's vehicle. An additional graphical indicator may be displayed if a driver is to take evasive action. For example, a large rightward facing arrow is displayed if a driver is to pull to the right to allow an REV to pass.

In some embodiments a driver may be alerted to the presence of an REV when the REV comes within a first proximity of his or her vehicle and may be instructed to move to the right when the REV comes within a second proximity of his or her vehicle, where the second proximity is closer to the vehicle than the first proximity. In this way a driver is given warning about the presence of the REV and the potential need to take evasive action prior to actually being instructed to take evasive action, allowing for a safer and more controlled evasive action at the appropriate time. In some embodiments the instruction is only provided when the REV is located behind the vehicle upon the same road of travel and ceases to be provided once the REV has passed the vehicle or is ahead of the vehicle by some distance threshold.

In some embodiments of the present invention user interface methods and apparatus are provided for lowering the volume and/or muting the stereo of a vehicle when an REV comes within certain proximity of that vehicle and/or when a determination is made that the REV is on the same road, traveling in the same direction, and/or may cross paths with the vehicle at or near an intersection. In some such embodiments the adjustment of volume is performed when the REV is located behind the vehicle upon the same road of travel and ceases to be performed once the REV has passed the vehicle or moves ahead of the vehicle by some distance threshold. In some embodiments the adjustment of volume is performed when the REV is determined to be on a possible intersecting path with the vehicle such as, for example at an intersection, and is not performed when it is determined that an intersecting path is not possible between the REV and the vehicle.

User interface methods and an apparatus are provided in some embodiments for alerting the driver of a vehicle as to the presence of an REV by playing a siren sound or other similar alert sound through the speakers of the vehicle. In some embodiments spatial placement audio techniques are used to make the siren sound seem to the user as if it is coming from the relative direction of the REV with respect to the vehicle. Such a spatial audio function is sometimes referred to as a 3-Dimensional (“3D”) audio function and employs spatial audio methods known to the art to produce a sound through a plurality of speakers such that the sound seems to the user as if it is coming from a particular direction. In this way, the audio alert provides both an indication of the presence of the REV and the relative direction of the REV with respect to the vehicle. In some such embodiments the volume of the audio alert is dependent upon the relative distance of the REV from the vehicle—the closer the distance, the louder the alert is played through the speakers. In this way the audio alert provides both an indication of the presence of the REV and the distance of the REV with respect to the vehicle. In some embodiments the audio display is provided when the REV is located behind the vehicle upon the same road of travel and ceases to be provided once the REV has passed the vehicle or is ahead of the vehicle by some distance threshold. In some such embodiments the audio display is provided when the REV is on a possible intersecting path of the vehicle at an intersection and is not provided when an intersecting path is not possible between the REV and the vehicle.

Some embodiments of the present invention provide user interface methods and apparatus that display a visual indication of the relative distance between the REV and the vehicle. In some h embodiments the visual indication includes a numerical display of the distance between the REV and the vehicle. The visual indication may include a graphical meter that represents the relative distance between the REV and the vehicle. In this way the driver is informed as to how near his or her vehicle is to the REV and may respond accordingly. The visual display may be provided when the REV is located behind the vehicle upon the same road of travel and ceases to be provided once the REV has passed the vehicle or is ahead of the vehicle by some distance threshold. In some embodiments the visual display is provided when the REV is on a possible intersecting path of the vehicle at an intersection and is not provided when an intersecting path is not possible between the REV and the vehicle.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a graphical system architecture that enables required information passing and computational determinations according to at least one embodiment of the invention;

FIG. 2a illustrates an overhead view of an example roadway (“R1”) upon which vehicles are traveling according to at least one embodiment of the invention;

FIG. 2b illustrates an overhead representation of road R1 at a future moment in time after the drivers of the vehicles responded to the alerts they received from their local computing devices according to at least one embodiment of the invention;

FIGS. 3a and 3b illustrate an overhead representation of road R2 according to at least one embodiment of the invention;

FIG. 4a illustrates a visual navigation system according to the prior art;

FIG. 4b illustrates a descriptive image of a navigation system according to at least one embodiment of the invention; and

FIG. 5 illustrates a descriptive image of a vehicle navigation system provided according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention provide enhanced methods and an apparatus for alerting drivers to emergency response vehicles in their vicinity using wireless communication and GPS tracking. More specifically, embodiments of the present invention provide an intelligent emergency vehicle alert system that informs a driver of a ground vehicle of the presence of a responding emergency vehicle (“REV”) by considering the relative location of the emergency vehicle with respect to the ground vehicle as well as considering one or more additional factors such as the road of travel, the direction of travel, a forward/aft comparison, and a road size determination. In this way the driver of the ground vehicle may be selectively alerted to the presence of an REV if that ground vehicle needs to take evasive action to allow the REV to pass, but may not be alerted to the presence of a responding emergency vehicle if no evasive action is required. In addition, embodiments of the present invention provide unique user interface methods and an apparatus by which the driver of the ground vehicle may be selectively alerted to the presence of the REV and/or may be instructed to take evasive action to allow the REV to pass. Embodiments of the present invention also provide unique user interface methods and an apparatus by which the driver of the ground vehicle is selectively alerted to the presence of the REV and instructed to take evasive action to allow the REV to pass in the event that the REV is determined to have a path of travel that may possibly intersect with the ground vehicle at an upcoming intersection. In this way, embodiments of the present invention provide advantages over the traditional alert method of using lights and sirens to inform drivers as to the presence of REVs in their vicinity and/or to instruct drivers to take evasive actions.

Embodiments of the present invention provide an improved warning system, replacing and/or supplementing lights and sirens with an intelligent emergency vehicle alert system that uses wireless communication technologies to specific alert drivers of vehicles that are ahead of an REV upon an affected road of travel and/or are crossing (or about to cross) an intersection that lies in the path of an emergency vehicle. The emergency vehicle alert system provides substantial benefits over current lights and siren methods, as is described in detail herein, including the ability to alert primarily those vehicles that need to take action, without confusing and/or unnecessarily alerting other vehicles that may be traveling in an opposite lane of traffic, on a side street, or are already are located behind the REV. Additionally, embodiments of the present invention provide unique user interface methods and an apparatus to alert drivers more effectively such as, for example, even when the drives are listening to loud music that would otherwise mask the sound of a siren. In this way embodiments of the present invention provide for more direct and informative alerting drivers to the presence of responding emergency vehicles and reduces the unnecessarily warning (and subsequent traffic slowing) of drivers in areas that do not need to take action. Embodiments of the present invention also relate to vehicle navigation systems and may employ certain features of vehicle navigation systems such as GPS tracking and a local store of road map data.

Embodiments of the present invention comprise an intelligent emergency vehicle alert system that selectively alerts the drivers of ground vehicles (e.g., cars, trucks, busses, and other road traveling vehicles that are enabled with the methods and apparatus disclosed herein) to the presence of a responding emergency vehicles in their vicinity and/or informs such drivers to take evasive action. More specifically, embodiments of the present invention selectively inform drivers of ground vehicles about the presence of an REV in his or her vicinity and/or advises the driver to take evasive action to allow the REV to pass if certain conditions are met relating to (I) the proximity of the REV with respect to the ground vehicle and (II) one or more of (a) the road of travel of the REV as compared to the road of travel of the ground vehicle, (b) the direction of travel of the REV as compared to the direction of travel of the ground vehicle, (c) the forward/aft relation of the REV with respect to the ground vehicle along the REV direction of travel, (d) the size and/or lane configuration of the road of travel of the REV, and/or (e) a determination that the road of travel of the REV and the road of travel of the ground vehicle may cross at an intersection that is forward of both the REV and the ground vehicle in their respective direction's of travel.

Embodiments of the present invention perform the above determinations by using a plurality of computing devices that are in networked communication and thereby operate in combination. The plurality of computing devices includes a local computing device that is located on board each ground vehicle for which the present invention is enabled. The plurality of computing devices also includes a local computing device local to each REV. The plurality of computing devices may also include a server that is external to the vehicles, where the server performs information-passing functions between the REV and each of the ground vehicles. The server is generally used to pass information about the presence and/or location of or more REVs to one or more ground vehicles. In some embodiments, some or all of the server functions may be performed by one or more local computing devices aboard one or more REVs and/or one or more ground vehicles. For clarity of the embodiments described herein, however, the embodiment that will be described in detail herein uses an external server that works in combination with a plurality of local computing devices that are located aboard ground vehicles and REVs. This server is referred to herein as a Vehicle Locative Server or “VLS.”

As used herein, “local computing device” should be broadly construed as including any mobile wireless client device that is associated with a vehicle and moves with that vehicle. A typical local computing device is a wireless access protocol (“WAP”)-enabled device that is capable of sending and receiving data in a wireless manner using the wireless application protocol. The WAP may support wireless networks, including Cellular Digital Packet Data (“CDPD”), Code Division Multiple Access (“CDMA”), Global System for Mobile Communications (“GSM”), Personal Digital Cellular (“PDC”), Personal Handy-phone System (“PHS”), Time Division Multiple Access (“TDMA”), FLEX, ReFLEX, Integrated Digital Enhanced Network (“iDEN”), Terrestrial Trunked Radio (“TETRA”), Digital Enhanced Cordless Telecommunications (“DECT”), DataTAC, and Mobitex, and it operates with many operating systems. Typically, WAP-enabled devices use graphical displays and can access the Internet (or another communication network) on so-called mini- or micro-browsers, which are web browsers with small file sizes that can accommodate the reduced memory constraints of portable devices and the low-bandwidth constraints of wireless networks. In one embodiment, the local computing device communicates over a cellular network, such as a GSM network. The local computing device, which may include telephone capabilities, video phone capabilities, email capabilities, text messaging capabilities, and other common communication capabilities, can communicate using one or more communication methods such as, for example short message service (“SMS”), enhanced SMS (“EMS”), multi-media message (“MMS”), email WAP, paging, or other known or later-developed wireless data formats. Embodiments of the present invention are not limited to WAP-enabled computing devices or to use of any particular type of wireless network. Such devices and networks are merely illustrative, and it should be appreciated that any wireless data communication technology now known or hereafter developed may be used.

Thus, embodiments of the present invention provide a computationally based emergency vehicle alert system that selectively alerts the driver of a ground vehicle about an REV based upon a determination that the proximity of the REV to the ground vehicle is below a certain threshold as well as by processing additional factors that indicate whether or not evasive action is required of the driver of that ground vehicle. For example, in one embodiment these additional factors include a requirement that the following conditions be satisfied: (a) the road of travel of the REV is the same as the road of travel of the ground vehicle, (b) the direction of travel of the REV is the same as the direction of travel of the ground vehicle, and (c) the ground vehicle is located ahead of the REV in the REV's direction of travel. When these conditions are met, the user interface of the present invention instructs the driver of the ground that he or she should pull to the right and thereby clear a path for the emergency vehicle to pass. Thus, embodiments of the present invention may be configured to selectively instruct the driver of a ground vehicle to pull to the right when an REV is approaching that vehicle from behind on that vehicles specific road of travel, without instructing the driver to pull to the right if the REV is on a different road of travel, if the REV is on the same road of travel but located ahead of the vehicle on that road, or if the REV is more than some threshold distance away from the ground vehicle. In this way, drivers of ground vehicles are selectively informed to take evasive action based upon more than just proximity of the REV to the ground vehicle.

Embodiments of the present invention may also be configured to consider the size and/or lane configuration of the road of travel of the REV and selectively inform vehicles traveling in the opposite direction of the REV to take evasive action. For example, if the road is sufficiently wide and/or has the directions of travel separated by a median or barrier, embodiments of the present invention may be configured to instruct drivers to pull to the right that are within certain proximity of the REV and (a) are in front of the REV in the REV's direction of travel, (b) are on the same road of travel as the REV, and (c) are traveling in the same direction as the REV, without instructing drivers to pull to the right if they are traveling in the opposite direction of the REV. In this way drivers of ground vehicles are selectively informed to take evasive action based upon more than just proximity of the REV to the ground vehicle. In this example, the traffic moving in the opposite direction of the REV is not as substantially affected by the presence of the REV.

On the other hand, if a road size and/or lane configuration is determined to be such that vehicles traveling in both directions must pull to the side to allow the REV to pass, the intelligent emergency vehicle alert system of the present invention may be configured to selectively alert the drivers of ground vehicles to take evasive action on both sides of that road. This can be accomplished by alerting drivers to pull to the right based upon a determination that (I) the proximity of the REV to that driver's ground vehicle is below a certain threshold as well (II) the following conditions being satisfied: (a) the road of travel of the REV is the same as the road of travel of the ground vehicle and (b) the ground vehicle is located ahead of the REV in the REV direction of travel. When these conditions are met, the user interface of embodiments of the present invention instructs the driver that he or she should pull to the right and thereby clear a path for the emergency vehicle to pass. Thus, embodiments of the present invention may selectively instruct drivers of ground vehicles to pull to the right when an REV is approaching their vehicle on their specific road of travel, without instructing drivers to pull to the right if the ground vehicle is on a different road of travel, if the ground vehicle is on the same road of travel but is already behind the REV in the REV's direction of travel, or if the REV is more than some threshold distance away from the ground vehicle.

In some embodiments of the present invention additional ground vehicles are alerted to the presence of the REV that are traveling upon a different road of travel than the REV if (a) the road of travel of the REV and the road of travel of the ground vehicle are determined to cross at an intersection, (b) if the location of that intersection is forward of the REV in the REV's direction of travel and is forward of the ground vehicle in the ground vehicle's direction of travel, and (c) if the REV and the ground vehicle are within certain proximity of each. If the above conditions are met, the driver of the ground vehicle is selectively alerted, for example, by instructing that driver to stop and/or slow and/or pull to the right and/or not enter the intersection that was determined to cross paths with the REV until the REV has passed. In this way ground vehicles that are upon different roads than the REV may be selectively alerted to take evasive action if their path of travel is determined to cross paths with the REV and their proximity is sufficiently near to the REV.

Embodiments of the present invention provide for the intelligent and selective alerting of ground vehicles with respect to an REV based at least in part upon factors other than the proximity of the REV to the ground vehicle. To enable selective alerting as described herein, embodiments of the present invention employ a plurality of computing devices in networked communication as mentioned previously. In general, the plurality of computing devices includes local computing devices proximal to each enabled ground vehicle and each enabled REV. The computational architecture employed for such a plurality of computing devices may take a variety of forms so long as it enables one or more computing devices to perform computational determinations that take into account at least two of the following factors: (a) the relative location of the REV and one or more ground vehicles, (b) the direction of travel of the REV and the direction of travel of one or more ground vehicles, (c) the road of travel of the REV, (d) the road of travel of one or more ground vehicles, (e) intersection between the road of travel of the REV and the road of travel of one or more ground vehicles, and (f) the size and/or lane configuration of the road of travel of the REV.

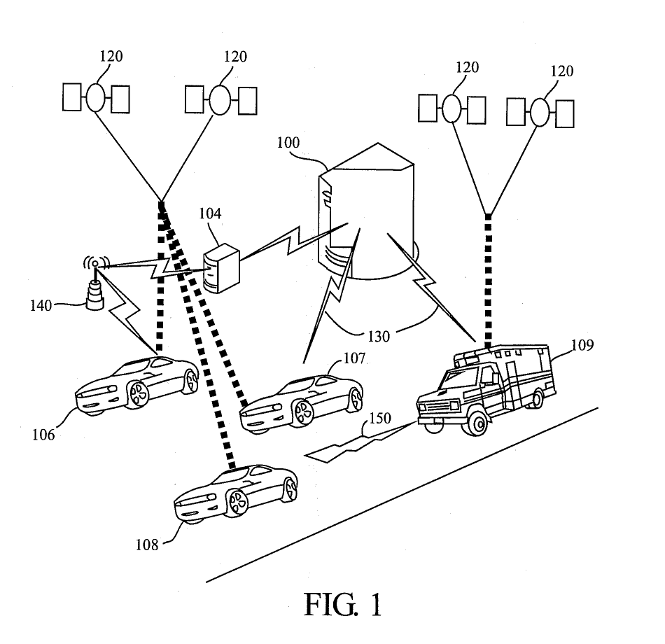

FIG. 1 illustrates a graphical system architecture that enables required information passing and computational determinations according to at least one embodiment of the invention. As shown FIG. 1, the system architecture includes at least one REV as indicated by ambulance 109. The REV is equipped with a local computing device (not shown) that performs software routines local to the vehicle. The REV is also equipped with a locative sensor that tracks the location of the REV within the physical world. The locative sensor may also track the orientation of the REV within the physical world. In this particular embodiment the locative sensor includes a GPS transducer that determines the current location of the REV by accessing data from a plurality of satellites 120 as shown. In this particular embodiment the locative sensor also includes a magnetometer for determining the orientation of the REV with respect to magnetic north.

The local computing device of the REV is configured to repeatedly read data from the GPS transducer and the magnetometer, where the data represents a current position and orientation of the REV within the physical world. The local computing device of the REV is also equipped with a wireless communication interface for communicating with one or more other computing devices over a network. A variety of communication methods may be used by the local computing device of the REV to communicate with external computing devices, for example Wi-Fi communication systems, cellular communication networks, or short-range radio networks. As shown in the figure, the REV 109 of this particular embodiment employs a Wi-Fi communication system to enable a wireless Internet connection 130 with external server 100. The external server 100 is referred to herein as the Vehicle Locative Server or “VLS” and is described in more detail below. As also shown in FIG. 1, the REV 109 also employs an optional vehicle-to-vehicle radio communication network 150 that enables wireless communication with the local computing device aboard one or more other vehicles such as vehicle 108. In general, the optional vehicle-to-vehicle radio communication network 150 is an ad-hoc network that is assembled among enabled vehicles using short-range radio transmissions. Although it is not shown, REV 109 may communicate through a mobile service provider 140 to server 100 through an optional gateway such as 104. Such a mobile service provider may comprise part of a cellular network.

Also shown in FIG. 1 is a plurality of ground vehicles such as automobiles shown with references 106, 107, and 108. Each of these vehicles is equipped with a local computing device (not shown) and that performs software routines local to the vehicle. Each vehicle may also be equipped with a locative sensor that tracks the location of the vehicle within the physical world. The locative sensor may also track the orientation of the vehicle within the physical world. In this particular embodiment the locative sensor includes a GPS transducer that determines the current location of the vehicle by accessing data from a plurality of satellites 120 as shown. In this particular embodiment the locative sensor also includes a magnetometer for determining the orientation of the vehicle with respect to magnetic north.

The local computing device of each vehicle is configured to repeatedly read data from the GPS transducer and the magnetometer local to that vehicle, the data representing a current position and orientation of the vehicle within the physical world. The local computing device of each vehicle is also equipped with a wireless communication interface for communicating with one or more other computing devices over a network. A variety of communication methods may be used by the local computing device of each enabled vehicle to communicate with external computing devices such as, for example, Wi-Fi communication systems, cellular communication networks, or short range radio networks. Vehicle 107 employs a Wi-Fi communication system to enable a wireless Internet connection 130 with an external VLS 100. As shown, vehicle 106 accesses a mobile service provider 140 to enable a wireless communication with an external server 100 through an optional gateway 104. Vehicle 108 may employ a vehicle-to-vehicle radio communication network 150 that enables wireless communication with one or more other vehicles such as REV 109. Although not shown, each vehicle may communicate through any one of the communication methods shown. Some embodiments may employ only Wi-Fi networks. Some embodiments may employ only cellular networks. Some embodiments may employ only vehicle-to-vehicle networks. Some embodiments support multiple communication methods.

Also illustrated in FIG. 1 is a Global Positioning System (“GPS”) 120 for use in tracking the location of ground vehicles 106, 107, and 108 and the REV 109. Each of the vehicles 106, 107, and 108 includes a local computing device that receives data from a GPS transceiver within the vehicle. The local computing device may be a single processor or a plurality of connected processors within the vehicle. The local computing device includes a user interface by which a user of the vehicle may enter information and/or make selections that influence routines running upon the local computing device. GPS technology provides latitudinal and longitudinal better than 3 feet may be achieved. This information may be obtained using a positioning system receiver and transmitter, as is well known in the art. The civilian service provided by Navistar GPS may be used in accordance with embodiments disclosed herein. Other positioning systems are also contemplated for use with embodiments of the present invention such as the next generation GPS system launched by the European Space Agency.

In order for current GPS to provide location information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In order to gain orientation information about a vehicle, one or more sensors may be included within or affixed to the vehicles. For example, a magnetometer may be employed to provide orientation information with respect to magnetic north. Alternately, orientation information may be inferred based upon two or more subsequent readings of positioning sensors such as GPS. In some embodiments, a plurality of GPS transducers may be employed at different locations within the vehicle to derive vehicle orientation. When sensors are employed they are generally connected directly or through a network or other data communication channel to the local computing device of the vehicle.

In order to gain direction of travel information about a vehicle, a plurality of subsequent GPS readings may be gathered over time and used to determine a direction of motion of the vehicle over that period of time. In some embodiments, additional sensors may be used to determine direction of motion information. For example, an accelerometer may be included to provide motion information about the vehicle. In some embodiments, a magnetometer may be employed to provide directional information about the vehicle. In some embodiments magnetometer data is used in combination with vehicle tachometer data to determine direction of motion of the vehicle. When sensors are employed, they are generally connected directly or through a network or other data communication channel to the local computing device of the vehicle.

In order to gain vehicle speed information about a vehicle, a plurality of subsequent GPS readings may be gathered over time and used to determine a speed of motion of the vehicle over that period of time. In some embodiments sensors may be employed to determine speed information. For example, a vehicle tachometer may be used to determine speed information. When speed sensors are employed they are generally connected directly or through a network or other data communication channel to the local computing device of the vehicle.

Thus, the local computing device of each ground vehicle and each REV according to the present invention is configured to read sensor information that indicates the current spatial location of that vehicle within the physical world as well as indicating other information such as the current orientation of the vehicle, the current direction of travel of the vehicle, and the current speed of the vehicle. The local computing device of REV may also receive data indicating whether or not the vehicle is currently responding to a call (and thus acting as an REV) or whether it is not responding to a call and thus acting as an ordinary vehicle as it moves through traffic.

The local computing device of each ground vehicle and each REV also has access to a database of road information that includes the layout and location of roads within the physical world. The database may also include information about the size and/or lane configuration of roads. The database may also include information about other objects and landmarks such as firehouses, gas stations, and hospitals. Such a database of road information is well known to the art of navigation systems and therefore will not be described in further detail herein. By accessing the database of road information and referencing the current location of its vehicle, the local computing device of each vehicle (i.e., each ground vehicle and each REV) may determine additional information such as the current road of travel of that vehicle, the current direction of travel of that vehicle upon that road of travel (i.e., northbound, southbound, eastbound, or westbound), the size and/or lane configuration of the current road of travel, and the presence of upcoming intersections that cross the current road of travel. In some common embodiments the database of road information is stored partially or fully locally to the vehicle within memory accessible to the local computing device of that vehicle. In some embodiments the database of road information may be stored partially or fully in an external computing device that is accessed and/or referenced remotely such as, for example, within the VLS 100.

The example embodiment shown in FIG. 1 therefore includes a plurality of ground vehicles, each configured with a local computing device, each able to track its location within the physical world, each having access to a database of road information by which the current road of travel of that vehicle may be determined from current locative information, each having access to directional information by which a current direction of travel may be determined for that vehicle, and each able to communicate with an external server. In addition, the example embodiment includes at least one REV 109 that is also configured with a local computing device, is also able to track its location within the physical world, has access to a database of road information by which the current road of travel of the REV may be determined from current locative information, has access to directional information by which a current direction of travel may be determined for that REV, and is also able to communicate with the external server. The external server is therefore operative to communicate with both the at least one REV and the plurality of ground vehicles and is operative to pass information between them, thereby completing a communication network between the REV and the plurality of ground vehicles.

As mentioned previously, there are a variety of architectural configurations that may be employed by embodiments of the present invention and a variety of ways to distribute the processing requirements among the plurality of computing devices employed. With respect to the specific embodiment shown in FIG. 1, the VLS 100 is operative to track the location and road of travel and direction of travel of the at least one REV 109 based upon information received from the REV 109 over the communication network. The VLS 100 is also operative to track the location and road of travel and direction of travel of each of a plurality of ground vehicles based upon information received from each of the plurality of ground vehicles over the communication network. The VLS 100 is also operative to communicate information about the REV 109 to at least one of the plurality of ground vehicles as needed to support the selective alerting features and functions of the present invention. The VLS 100 may also be operative to communicate information about one or more ground vehicles to the REV 109 to enable the driver of the REV 109 to better plan his or her driving path.

In one embodiment of the present invention, the VLS 100 is operative to repeatedly receive current locative data from one or more REVs and store that data in memory along with a unique identifier by which each of the one or more REVs may be uniquely addressed. Similarly, the VLS 100 is operative to repeatedly receive current locative data from one or more ground vehicles and store that data in memory along with a uniquely identifier by which each of the one or more ground vehicles may be uniquely addressed. The locative data may include GPS locations. The locative data may also include current road of travel information. The locative data may also include current direction of travel information. The locative data may also include current speed information. The locative data may also include current vehicle orientation information. The store of memory that maintains such information about each of a plurality of ground vehicles and one or more REVs is referred to herein as a “Vehicle Locative Database” and it is updated regularly to reflect current locative information about vehicles.

Thus, as shown in the example embodiment of FIG. 1, the VLS 100 is provided that is in wireless communication with at least one REV 109 and a plurality of ground vehicles 106, 107, and 108. The VLS 100 may be implemented as a managed service (e.g., in an ASP model) that drivers subscribe to or that is provided as part of another service such as a cellular service or a vehicle navigation service. In some embodiments it may be a free emergency service that is maintained by an emergency agency. For illustrated purposes, the VLS 100 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive functionality described below. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly routable Internet, a corporate intranet, a private network, or any combination thereof, depending on the desired implementation environment. As illustrated FIG. 1, the VLS 100 may also be also in communication with a mobile service provider through a gateway, such as gateway 104. Thus the VLS 100 may communicate with the local computing device of one or more vehicles through a cellular network and/or other network, for example, an Internet based network.

Thus as shown in FIG. 1, a plurality of vehicles (ground vehicles and REVs) are equipped such that each vehicle has one or more locative sensors and a communication link to the VLS 100. Each vehicle is configured through software upon its local computing device to report locative data to the VLS 100 repeatedly when actively using embodiments of the present invention. In some embodiments the local computing device of each vehicle is configured to send locative information including at regular time intervals to the VLS 100. In some embodiments the local computing device of each vehicle is configured to send locative information to the VLS 100 at a time interval that is dependent upon the vehicles velocity (in general the time interval is less when the velocity is greater). In some embodiments the local computing device of each vehicle is configured to send locative information to the VLS 100 each time the vehicle has moved a certain distance. By making the locative information update rate dependent upon vehicle velocity and/or upon incremental vehicle displacement, a vehicle sitting at a stoplight need not update its location information as quickly as a vehicle traveling quickly upon a freeway. Similarly, a slow moving vehicle need not update its location information as quickly as a fast moving vehicle. Such methods save communication bandwidth to the VLS 100.

The VLS 100, as described previously, maintains a vehicle locative database of vehicles that are currently using the service. The locative database may be maintained upon the same machine that runs the VLS 100 application or may be accessed from a separate machine over a communication network. Thus the locative server, alone or in combination with other computing machines, is operative to maintain a database of a plurality of currently active vehicles, each indexed by a unique identifier, the database including a substantially current location and substantially current direction of travel for each. The current location may be, for example, a current GPS location for the vehicle. The current location may also include the current road of travel of the vehicle. The current direction of travel may be, for example, northbound, southbound, eastbound, or westbound, on the current road of travel. The database may also include a unique messaging address (“UMA”) for each vehicle, where the UMA is an electronic addressing means by which digital communications can be uniquely directed to that particular vehicle. In some embodiments the unique identifier and the UMA are the same. In some embodiments, the UMA and the unique identifier are different but relationally associated by the database.

As discussed above, some embodiments the current location information stored by the VLS 100 includes the current road of travel for each vehicle, identifying the road (e.g., road, street, avenue, highway, freeway, or other naming convention for a road accessible by ground vehicles) upon which that vehicle is currently traveling. The current road of travel may also include a locative identifier as to where upon the length of the road the vehicle currently is. In some embodiments the current road information may also include the lane of the road in which the vehicle is currently located.

By current location, current direction of travel, and current road of travel, it is understood that there may be some time lag that causes the locative data stored for some or all vehicles to reflect that vehicle's location and/or direction of travel at a recent time in the past. It is therefore desirable for embodiments of the current invention to keep such time lags as small as possible within the practical limitations of the technology employed. It is also often desirable for the locative server to store a time-history of current locations for the plurality of vehicles, the time-history reflecting one or more previous but recent locations of each of the plurality of vehicles. It is also sometimes desirable for the locative server to store a current speed for each of the plurality of vehicles, where the current speed is derived from speed data received from each vehicle, from the time history of current locations for each vehicle, or a combination of both. Furthermore, in some embodiments of the present invention the VLS 100 and/or the local computing device of a vehicle may be operative to predict a more current location of a vehicle based at least in part upon the recent stored time-history of previous locations of that vehicle and/or a most recent speed of the vehicle and/or a most recent direction of travel of the vehicle.

It should be noted that in some embodiments the current road location information may be determined for each vehicle by the VLS 100 by cross-referencing a GPS location for that vehicle (or other spatial location coordinate) with a stored map database of road locations accessible to the server. In this way the VLS 100, upon receiving locative coordinates for each vehicle, may determine the current road location information for that vehicle. In some embodiments the current road location information for a particular vehicle may be determined by the local computing device of that vehicle by cross referencing a GPS location for that vehicle (or other spatial location coordinate) with a stored map database of road locations accessible to the local computing device. In such embodiments the local computing device of a vehicle may communicate some or all of the current road location information about that vehicle to the VLS over the wireless communication link.

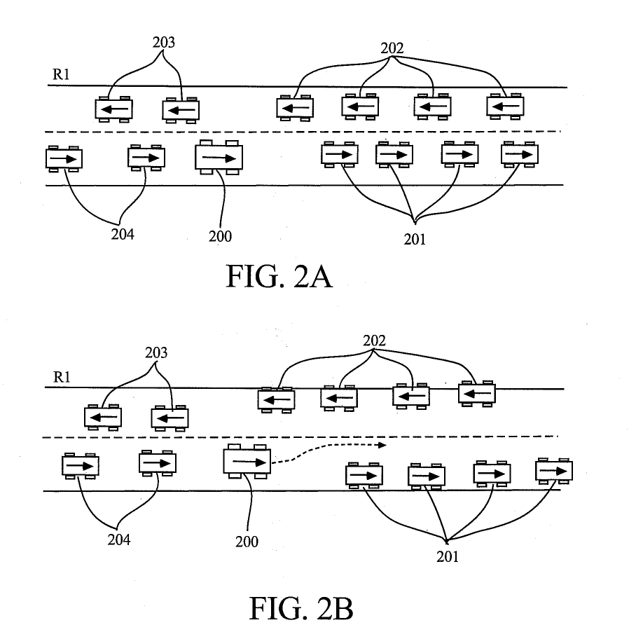

FIG. 2a illustrates an overhead view of an example roadway (“R1”) upon which vehicles are traveling according to at least one embodiment of the invention. As shown, R1 runs east-west with eastbound traffic drawn in the lower lane and westbound traffic drawn in the upper lane. Each vehicle in the figure is represented by an iconic overhead image with an arrow drawn upon it to show its direction of travel. An REV is shown by vehicle icon 200. The REV 200 is in the eastbound lane of traffic and is traveling in the eastbound direction. Also traveling in the eastbound lane is a plurality of ground vehicles including ground vehicles 201 which are forward of REV 200 in the eastbound lane of traffic and ground vehicles 204 which are behind REV 200 in the eastbound lane of traffic. A plurality of ground vehicles traveling in the westbound lane of traffic is also present, including ground vehicles 203 and 202. As shown, ground vehicles 202 are located forward of REV 200 and ground vehicles 203 are located behind REV 200.

As was described with respect FIG. 1, the REV 200 has a local computing device on board, a local positional sensor on board, a local database of road information, and a wireless communication link to a VLS. The local computing device of REV 200 repeatedly reads the locative sensors and determines a current location, current direction of travel, current road of travel, and current speed of the REV. The local computing device of REV 200 communicates this information the VLS, which stores it in memory along with unique identifying information by which the REV may be distinguished from other REV vehicles that may also be tracked by the VLS. In addition, each of the ground vehicles 201, 202, 203, and 204 has a local computing device on board, a local positional sensors on board, a local database of road information, and a wireless communication link to a VLS. The local computing device of each ground vehicle 200 repeatedly reads the locative sensors and determines a current location, current direction of travel, a current road of travel, and current speed of the vehicle. The local computing device of each ground vehicle communicates this information the VLS which stores it in memory along with unique identifying information by which each ground vehicle may be uniquely distinguished from other ground vehicles being tracked by the VLS. The VLS also maintains a unique electronic address for each REV and each ground vehicle such that the VLS can selectively communicate with each using its unique address, individually or in groups.

The VLS thus maintains in memory current data as to the GPS location of a plurality of ground vehicles, including their direction of travel and their road of travel. The VLS also maintains in memory current data as to the GPS location of one or more REVs. For each REV being tracked by the vehicle locative server, the VLS application processes the data and determine which ground vehicles are to be sent locative data regarding that REV. A variety of methods may be used depending upon how processing is shared among computers. In this particular embodiment the VLS application performs a proximity analysis determining which ground vehicles that are being tracked within the vehicle locative database are currently within a certain proximity of each REV and communicates locative data about that REV to those ground vehicles. In some embodiments, the certain proximity used is a fixed value. In other embodiments the certain proximity used is dependent upon the size and/or lane configuration and/or speed limit of the road upon which the REV is traveling. For example if the road is a large road and/or has a fast speed limit (such as a highway) the certain proximity used may be selected as larger than if the road is a smaller road and/or has a slower speed limit. This is because vehicles may require warning when an REV is a greater distance away on large rounds of rapid vehicle motion (such as highways) as compared to small side streets. In other embodiments the certain proximity used is dependent upon the current (and/or recent and/or average) speed of the REV. For example if the REV is moving quickly the certain proximity used may be selected as larger than if the REV is moving at a slower speed. This is because ground vehicles may require warning when the REV is a larger distance away when an REV is approaching at a higher rate of speed.

Thus the VLS application performs an analysis upon the locative data stored for the REV and for a plurality of vehicles to determine which vehicles are currently within a certain proximity of the REV. The certain proximity used may be a fixed value or may be dependent upon variable factors such as the speed of the REV, the size of the road, the speed limit of the road, and/or the traffic density on the road.

Upon determining which ground vehicles are currently within a certain proximity of the REV, the VLS sends locative data to those ground vehicles regarding the REV. These ground vehicles are referred to herein as the “Target Set” of ground vehicles. The Target Set may change repeatedly over time has the locations of the REV and the locations of ground vehicles vary over time. The locative data sent to the Target Set of ground vehicles generally includes the most current location data stored by the VLS about the REV. The locative data may also include current direction of travel data for the REV, current road of travel data for the REV, and/or current speed data for the REV. The locative data is repeatedly sent to the Target Set, preferably at a rapid rate so that the Target Set ground vehicles have up to date locative data regarding the REV.

Upon receiving locative data regarding the REV from the locative server, the local computing device each ground vehicle in the target set is operative to perform a determination as so whether or not the driver of that vehicle needs to be informed of the REV and/or whether or not the driver of that vehicle needs to be instructed to take evasive action related to the REV. It should be noted that while this determination is performed by the locative computing device of each ground vehicle in this embodiment, in some embodiments the part or all of the determination may be performed by the VLS.

In the present example, all ground vehicles shown in FIG. 2a (i.e., ground vehicles 201, 202, 203, and 204) are all within the Target Set related to REV 200 based upon their close proximity and therefore all receive locative data regarding REV 200 from the VLS. The local computing device of each ground vehicle then performs a determination as to whether or not the driver of that vehicle needs to be informed of the REV and/or whether or not the driver of that vehicle needs to be instructed to take evasive action related to the REV. More specifically with respect to each individual ground vehicle in the Target Set, the local computing device of that ground vehicle selectively informs the driver of that ground vehicle about the presence of the responding emergency vehicle (REV) and/or advises the driver to take evasive action if certain conditions are met relating to: (I) the proximity of the REV with respect to the ground vehicle and (II) one or more of (a) the road of travel of the REV as compared to the road of travel of the ground vehicle, (b) the direction of travel of the REV as compared to the direction of travel of the ground vehicle, (c) the forward/aft relation of the REV with respect to the ground vehicle along the REV direction of travel, (d) the size and/or lane configuration of the road of travel of the REV, and/or (e) a determination that the road of travel of the REV and the road of travel of the ground vehicle may cross at an intersection that is forward of both the REV and the ground vehicle in their respective direction's of travel.

In this particular embodiment, the first assessment that is performed by the local computing device of each ground vehicle in the target set is a determination regarding the proximity of that ground vehicle with respect to the REV. This assessment is performed by a computing device of each ground vehicle by comparing the current location of that ground vehicle with the current location of the REV. If the distance between the REV and the ground vehicle is greater than a defined proximity threshold, then it is determined that the driver does not need to be informed and/or that no evasive action is required. If the distance is less than the proximity threshold, the driver may need to be alerted and/or instructed to take evasive action and so the assessment continues with regard to other factors. It should be noted that the proximity threshold used in this step is generally smaller than the threshold used by the VLS to determine the target set. It should also be noted that this assessment is generally performed repeatedly because both the REV and the ground vehicle are in motion and so they may come within the threshold proximity of each other at a future moment in time. A plurality of proximity thresholds may be used, such as a first proximity threshold to determine whether the driver should be informed about the presence of the REV, and a second proximity threshold used to determine whether the driver should be instructed to take evasive action. In general the first proximity threshold is larger than the second proximity threshold, causing the driver first to be informed that an REV is nearing and then when the distance between them closes further, the driver is instructed to take evasive action. As was true in the proximity threshold used by the VLS, the proximity thresholds used in the current assessment step may be fixed values or may be of a value that is be dependent upon factors such as the size of the road, the speed of the REV, the speed limit of the road, and/or the current traffic conditions.

Referring specifically to the example shown in FIG. 2a, a determination is made by the local computing device of any one of the ground vehicles (201, 202, 203, or 204) that the vehicle is within the defined certain proximity of REV 200. In this example the certain proximity used is 200 yards.

Once it is determined that the REV is within a certain threshold distance of the ground vehicle (for example, 200 yards), the next assessment performed by the local computing device of each ground vehicle is regarding the road of travel of the REV and the ground vehicle. By accessing road data from the road information database, a determination is made regarding which road the REV is traveling upon based upon the current location of the REV (and/or based upon information received directly from the VLS). For the example shown in FIG. 2a, it is determined that REV 200 is currently traveling upon road R1. Similarly, by accessing data from a road information database it is determined based upon the current location of the ground vehicle what road it is traveling upon. It is determined by the local computing device of any one of the ground vehicles (201, 202, 203, or 204) that the ground vehicle is traveling upon road R1. Thus, a determination is made that confirms that the REV and the ground vehicle are both traveling upon the same road (in this case, road R1).

The next assessment that is performed by the local computing device of the ground vehicle is regarding the size of road that both the ground vehicle and the REV are traveling upon. In the example of FIG. 2a, the road is R1 and so by accessing road data from the road information database, it is determined based upon the current location of the ground vehicle that road R1 at that location is a narrow road that requires evasive action for vehicles on both sides to allow an REV to pass.

The next assessment that is performed by the local computing device of the ground vehicle is regarding the forward/aft location of the ground vehicle with respect to the direction of travel of the REV. More specifically, based upon the location of the REV upon its road of travel and the direction of travel of the REV upon its road of travel it is determined whether or not the ground vehicle (which has been determined already to be on the same road of travel) is located ahead or behind the REV within its direction of travel. For the particular embodiment shown in FIG. 2a, this assessment will be different for the local computing devices of the various ground vehicles shown. For example, the ground vehicles shown at 201 will perform this assessment and based upon their location, the location of the REV, and the direction of travel of the REV upon road R1. Based upon these factors it is determined by the local computing device of each of vehicle 201 that it is located forward of the REV in the REVs direction of travel upon road R1. Thus, it is determined by the local computing device of each of these vehicle 201 that the driver need to be informed of the REV and needs to be instructed to take evasive action to allow the REV to pass. Similarly, the ground vehicles shown at 202 will perform this assessment and based upon their location, the location of the REV, and the direction of travel of the REV upon road R1. Based upon these factors it is determined by the local computing device of each of vehicle 202 that it is located forward of the REV in the REVs direction of travel upon road R1. Thus, it is determined by the local computing device of each of these vehicle 202 that the driver need to be informed of the REV and needs to be instructed to take evasive action to allow the REV to pass. In addition, the ground vehicles shown at 203 will perform this assessment and based upon their location, the location of the REV, and the direction of travel of the REV upon road R1. Based upon these factors it is determined by the local computing device of each of vehicle 203 that it is located behind of the REV in the REVs direction of travel upon road R1. Thus it is determined by the local computing device of each of these vehicles 203 that the driver does not need to be informed of the REV and does not need to be instructed to take evasive action to allow the REV to pass. In addition, the ground vehicles shown at 204 will perform this assessment and based upon their location, the location of the REV, and the direction of travel of the REV upon road R1. Based upon these factors, the local computing device of each of vehicle 204 that it is located behind of the REV in the REVs determine the direction of travel upon road R1. Thus, the local computing device of each of these vehicles 204 determines that the driver does not need to be informed of the REV and does not need to be instructed to take evasive action to allow the REV to pass.

If road size and/or lane configuration is determined to be such that vehicles traveling in both directions must pull to the side to allow the REV to pass, the intelligent emergency vehicle alert system may be configured to selectively alert the drivers of ground vehicles to take evasive action on both sides of that road. This can be accomplished by alert drivers to pull to the right based upon determination that (I) the proximity of the REV to that driver's ground vehicle is below a certain threshold as well (II) the following conditions being satisfied: (a) the road of travel of the REV is the same as the road of travel of the ground vehicle and (b) the ground vehicle is located ahead of the REV in the REV direction of travel. When these conditions are met, the user interface of the present invention instructs the driver that he or she should pull to the right and thereby clear a path for the emergency vehicle to pass. Thus, embodiments of the present invention may selectively instruct drivers of ground vehicles to pull to the right when an REV is approaching their vehicle on their specific road of travel but NOT instruct drivers to pull to the right if the ground vehicle is on a different road of travel, if the ground vehicle is on the same road of travel but is already behind the REV in the REV's direction of travel, or if the REV is more than some threshold distance away from the ground vehicle.

The local computing device of each of the ground vehicles in the current example performs the above assessment and takes different action depending upon the results of the assessment. All ground vehicles (201, 202, 203, and 204) were determined to be within the defined proximity threshold of the REV and all were determined to be on the same road of travel (R1) as the REV, but only ground vehicles 201 and 202 were determined to be ahead of the REV in the REVs direction of travel upon road R1. Thus, only the local computing devices of ground vehicles 201 and 202 generated an alert to their drivers indicating the presence of the REV and instructing their drivers to take evasive action. The alert displayed to the drivers of vehicles 201 and 202 may be visual, audio, or both, as described elsewhere within this document. The alert instructs the driver to take evasive action, moving to the right to allow the REV to pass.

FIG. 2b illustrates an overhead representation of road R1 at a future moment in time after the drivers of the vehicles responded to the alerts they received from their local computing devices according to at least one embodiment of the invention. As shown, ground vehicles 201 and 202 have taken evasive action, moving to the side. This has cleared a path for REV 200. Meanwhile, ground vehicles 203 and 204 did not alert their drivers and instruct them to take evasive action, and so these vehicles continue moving forward normally as shown in FIG. 2b. Thus, some vehicles upon road R1 and within certain proximity of REV 200 are alerted and instructed to take evasive action and other vehicles are not. This is performed using an intelligent selective alerting method such that vehicles that do not need to be alerted are not alerted and vehicles that do need to take evasive action are alerted. It should be noted that in some embodiments the drivers of all vehicles (i.e., 201, 202, 203, and 204) within a certain proximity may be informed of the presence of the REV by the user interface of the local computing device of the vehicle of but only the drivers of certain vehicles (i.e., 201 and 202) may be instructed to take evasive action (e.g., to pull to the side and allow the REV to pass). It should also be noted that the assessments described above are repeatedly performed based upon the changing locations of the REV and each ground vehicle. For example, once the REV passes a ground vehicle upon the road, the local computing device of that vehicle will change its assessment and no longer instruct the driver of that vehicle to take evasive action. It should also be noted that the local computing devices of each ground vehicle may simultaneously perform such assessments with respect to a plurality of different REV vehicles if a plurality of REVs are near the ground vehicle at the same time.

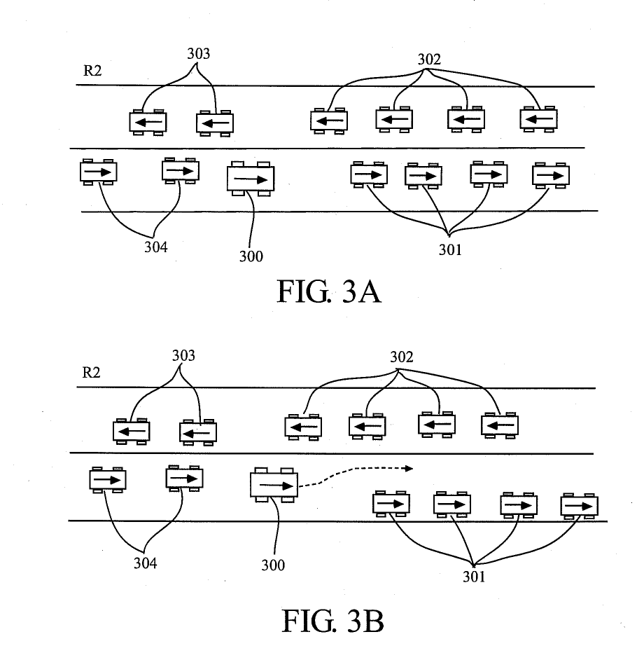

FIGS. 3a and 3b illustrate an overhead representation of road R2 according to at least one embodiment of the invention. The example shown here is similar to that of FIGS. 2a and 2b with the only difference being that the road R2 is substantially wider and includes a median barrier. As a result, the REV may pass with only vehicles traveling in the same direction of the REV taking evasive action. The present example shows how the methods of embodiments of the present invention may be configured to consider this different condition and takes different actions. For example, all ground vehicles shown in FIG. 3a (i.e., 301, 302, 303, and 304) are all identified as being within the Target Set by the VLS based upon their proximity to REV 300. Thus, all ground vehicles (301, 302, 303, and 304) receive locative data regarding REV 300 from the VLS. This data is repeatedly updated over time. Using the most up-to-date data, the local computing device of each ground vehicle then performs a determination as to whether or not the driver of that vehicle needs to be informed of the REV and/or whether or not the driver of that vehicle needs to be instructed to take evasive action related to the REV.

The first assessment that is performed by the local computing device of each ground vehicle is a determination regarding the proximity of that ground vehicle with respect to the REV. This assessment is performed by a computing device of each ground vehicle by comparing the current location of that ground vehicle with the current location of the REV. If the distance between the REV and the ground vehicle is greater than some proximity threshold, then it is determined that the driver does not need to be informed and/or that no evasive action is required. If, on the other hand, the distance is less than some proximity threshold, the driver may need to be informed and/or may need to take evasive action, and so the assessment continues. Referring specifically to FIG. 3a, it is determined by the local computing device of any one of the ground vehicles (301, 302, 303, or 304) that the vehicle is within a defined certain proximity of REV 300 and so for these vehicles the assessment continues.

Once it is determined that the REV is within a certain threshold distance of the ground vehicle (for example, 200 yards), the next assessment performed by the local computing device of each ground vehicle is regarding the road of travel of the REV and the ground vehicle. By accessing road data from the road information database, a determination is made based upon the current location of the REV (and/or based upon information received directly from the VLS) as to which road the REV is traveling upon. For the example shown in FIG. 3a, it is determined that REV 300 is currently traveling upon road R2. Similarly, by accessing data from the road information database it is determined based upon the current location of the ground vehicle what road it is traveling upon. For the example shown in FIG. 3a, it is determined by the local computing device of any one of the ground vehicles (301, 302, 303, or 304) that the ground vehicle is traveling upon road R2. Thus, a determination is made that confirms that the REV and the ground vehicle are both traveling upon the same road (in this case, road R2).

The next assessment that is performed by the local computing device of the ground vehicle is regarding the size of road that both the ground vehicle and the REV are traveling upon. In the example of FIG. 3a, the road is R2 and so by accessing road data from the road information database, it is determined based upon the current location of the ground vehicle that road R2 at that location is a wide road with a median that separates opposing traffic. For such a road it is determined that evasive action is only required for vehicles on the same side of the road as the REV to allow the REV to pass. In other words, it is determined that evasive action is only required for vehicles that are traveling in the same direction as the REV on road R2 and not for vehicles traveling in the opposite direction of the REV on road R2. This means that of the plurality of vehicles (301, 302, 303, and 304) that are performing assessments upon their local computing devices, only those vehicles that determine that they are traveling in the same direction as the REV may need to alert their driver and/or instruct their driver to take evasive action. Thus, based upon this assessment step, the local computing devices of vehicles 302 and 303 determine that their drivers do not need to be alerted and/or do not need to be instructed to take evasive action. Alternately, based upon this assessment step, the local computing devices of vehicles 301 and 304 determine that their drivers may need to be alerted and/or may need to be instructed to take evasive action.

The next assessment that is performed by the local computing device of the ground vehicle is regarding the forward/aft location of the ground vehicle with respect to the direction of travel of the REV. More specifically, based upon the location of the REV upon its road of travel and the direction of travel of the REV upon its road of travel it is determined whether or not the ground vehicle (which has been determined already to be on the same road of travel and in the same direction of travel) is located ahead or behind the REV within the REV's direction of travel. For the particular embodiment shown in FIG. 3a, this assessment will be different for the local computing devices of the various ground vehicles shown. For example, the ground vehicles shown at 301 will perform this assessment and based upon their location, the location of the REV, and the direction of travel of the REV upon road R2. Based upon these factors, the local computing device of each of vehicle 301 that it is located forward of the REV determines the REV's direction of travel upon road RI. Thus, the local computing device of each of these vehicle 301 determines that the driver need to be informed of the REV and needs to be instructed to take evasive action to allow the REV to pass. Alternatively, the ground vehicles shown at 304 will perform this same assessment and based upon their location, the location of the REV, and the direction of travel of the REV upon road R2. Based upon these factors it is determined by the local computing device of each of vehicle 304 that it is located behind of the REV in the REV's direction of travel upon road R2. Thus, it is determined by the local computing device of each of these vehicle 304 that the driver does not need to be informed of the REV and does not need to be instructed to take evasive action to allow the REV to pass.

If road size and/or lane configuration is determined to be such that only vehicles traveling in the same directions as the REV must pull to the side to allow the REV to pass, the intelligent emergency vehicle alert system of embodiments of the present invention may be configured to selectively alert the drivers of ground vehicles to take evasive action that are on the same side of the road as the REV and not alert drivers on the opposite side of the road. In addition, the intelligent emergency vehicle alert system of the present invention may be configured to selectively alert drivers that are forward of the REV in the REV's direction of travel, but not alert drivers that are behind the REV. This can be accomplished by alert drivers to pull to the right based upon determination that (I) the proximity of the REV to that driver's ground vehicle is below a certain threshold as well as (II) the following conditions being satisfied: (a) the road of travel of the REV is the same as the road of travel of the ground vehicle, (b) the ground vehicle is located ahead of the REV in the REV direction of travel, and (c) the ground vehicle is traveling in the same direction as the REV. When these conditions are met, the user interface of the present invention instructs the driver that he or she should pull to the right and thereby clear a path for the emergency vehicle to pass. Thus, embodiments of the present invention may selectively instruct drivers of ground vehicles to pull to the right when an REV is approaching their vehicle from behind on their road of travel, without instructing drivers to pull to the right if the ground vehicle is on a different road of travel, if the ground vehicle is on the same road of travel but is behind the REV while moving in the same direction of travel as the REV, if the REV is traveling in the opposite direction on the road of travel as compared to the REV, or if the REV is more than some threshold distance away from the ground vehicle.

Thus, the local computing device of each of the ground vehicles in the current example performs the above assessment and takes different action depending upon the results of the assessment. All ground vehicles (301, 302, 303, and 304) were determined to be within the defined proximity threshold of the REV and all were determined to be on the same road of travel (R2) as the REV, but only ground vehicles 301 and 304 were determined to traveling in the same direction as the REV, and of those only ground vehicles 301 were determined t be ahead of the REV in the REV's direction of travel. Thus, only the local computing devices of ground vehicles 301 generated an alert to their drivers indicating the presence of the REV and instructing their drivers to take evasive action. The alert displayed to the drivers of vehicles 301 may be visual, audio, or both, as described elsewhere within this document. The alert instructs the driver to take evasive action, moving to the right to allow the REV to pass.

FIG. 3b shows an overhead representation of road R2 at a future moment in time after the drivers of the vehicles responded to the alerts they received from their local computing devices. As shown, ground vehicles 301 have taken evasive action, moving to the side, thereby clearing a path for REV 300 to pass. Meanwhile, ground vehicles 302, 303, and 304 did not instruct their drivers to take evasive action, and so we see these vehicles continuing forward normally in FIG. 3b. Thus, some vehicles upon road R2 and within certain proximity of REV 300 are alerted and instructed to take evasive action and other vehicles are not. This is performed by using an intelligent selective alerting method such that vehicles that do not need to be alerted are not alerted and vehicles that do need to take evasive action are alerted. It should be noted that in some embodiments the drivers of all vehicles (i.e., 301, 302, 303, and 304) may be informed of the presence of the REV by the user interface of the local computing device of that vehicle of but only the drivers of certain vehicles (e.g., 301) may be instructed to take evasive action (e.g., to pull to the side and allow the REV to pass). It should also be noted that the assessments described above are repeatedly performed based upon the changing locations of the REV and each ground vehicle. For example, once the REV passes a ground vehicle upon the road, the local computing device of that vehicle will change its assessment and no longer instruct the driver of that vehicle to take evasive action. It should also be noted that the local computing devices of each ground vehicle may simultaneously perform such assessments with respect to a plurality of different REV vehicles if a plurality of REVs are near the ground vehicle at the same time.

In some embodiments of the present invention additional ground vehicles are alerted to the presence of an REV that are traveling upon a different road of travel than the REV if (a) the road of travel of the REV and the road of travel of the ground vehicle are determined to cross at an intersection, (b) the location of that intersection is forward of the REV in the REV's direction of travel and is forward of the ground vehicle in the ground vehicle's direction of travel, and (c) the REV and the ground vehicle are within certain proximity of each other. If the above conditions are met, the driver of a ground vehicle is selectively alerted by the present invention, for example by instructing that driver to stop and/or slow and/or pull to the right and/or not enter the intersection that was determined to cross paths with the REV until the REV has passed. In this way ground vehicles that are upon different roads than the REV may be selectively alerted to take evasive action if their path of travel is determined to cross paths with the REV and if their proximity is sufficiently near to the REV.

The process for alerting ground vehicles based upon crossing paths with an REV follows similar steps as the process for alerting ground vehicles based upon a need to allow an REV to pass when traveling upon the same road. For example, the process begins with the VLS determining that a ground vehicle is within a certain proximity threshold of an REV. The VLS then sends locative information regarding the REV to the ground vehicle. The local computing device of the ground vehicle then determines if the current road of travel of the REV crosses the current road of travel of the ground vehicle. This assessment is performed by accessing road data from the road information database. For example, by accessing road data from the road information database based upon the current location of the REV it is determined what road the REV is traveling upon (for example, road R51) In some embodiments this road information is send directly from the VLS. In addition, by accessing road data form the road information database, it is determined based upon the current location of the ground vehicle what road it is traveling upon (for example road, R22). Based upon data from the road information database, it may be determined if road R51 crosses toad R22 at an intersection. If so, the location of the intersection is compared to the current location of the REV and the current location of the ground vehicle, with consideration for each of their current directions of travel, to determine if the location of the intersection is both (a) forward of the REV in the REV's direction of travel and (b) forward of the ground vehicle in the ground vehicles direction of travel. If so, there is a possibility for a collision if the two vehicles reach the intersection at or about the same time and thus the driver of the ground vehicle may need to be alerted and/or instructed to take an evasive action. The next assessment is a determination of proximity between the REV and the ground vehicle. This assessment determines if the REV and the ground vehicle are within a certain collision danger proximity threshold as they approach the intersection on their respective roads and/or their respective directions. For example, the REV is approaching the intersection of possible collision on road R51 at its particular speed and the ground vehicle is approaching the intersection of possible collision on road R22 at its particular speed. If they come within the certain Collision Danger Proximity Threshold (which may be, for example, 200 yards), the driver of the ground vehicle is alerted about the REV and/or instructed to take evasive action. The Collision Danger Proximity threshold may be a fixed value or may be a value that is determined based at least in part upon the speed of travel of the REV, the speed of travel of the ground vehicle, or both. Similarly the threshold may be determined based at least in part upon the size of the roads of travel (i.e., R51 and/or R22) and/or upon the speed limits of the roads of travel.

In some embodiments, a first collision danger proximity threshold and a second collision danger proximity threshold are defined and used such that the driver of the ground vehicle is alerted to the presence of the REV when the two vehicles come within the first collision danger proximity threshold of each other and the driver of the ground vehicle is instructed to take evasive action when the two vehicles come within the second collision danger proximity of each other. In general, the first threshold distance is larger than the second threshold distance. In this way, when an REV and a ground vehicle are approaching an intersection where they could possibly collide based upon their directions of travel, the driver of the ground vehicle is alerted to the possibility of the collision when he comes within a first threshold distance of the REV (for example, 200 yards) and is instructed to take evasive action when he comes within the second threshold distance of the REV (for example, 100 yards). In some embodiments, the driver is alerted to take evasive when he comes within certain proximity of the intersection if the REV is also within some proximity of the intersection. The evasive action instructed to the driver by the user interface may be a warning to slow and/or stop and/or NOT enter the intersection until the REV has passed.

It should be noted that in the examples above, some or all of the processing performed by the local computing device of each ground vehicle may be performed by the VLS. Similarly, some or all of the data processing and data passing performed of the VLS may be performed by a network of local computing devices that communicate directly to one or more REV vehicles through a vehicle to vehicle network. Thus, a variety of computational architectures may be employed to enable the features and functions of embodiments of the present invention.

Specific user interface features and functions may be utilized in accordance with embodiments of the present invention. These features and functions are controlled by the local computing device of a ground vehicle and are the methods by which the local computing device alerts the driver to the presence of an REV and/or instructs the driver to take evasive action. A wide variety of user interface methods may be employed, using visual displays, audio displays, and/or a combination of the two. A few novel user interface methods that provide specific inventive benefits are described below.

In some embodiments of the present invention a graphical display is used within a ground vehicle to indicate the presence of a nearby REV to the driver of that ground vehicle. In some such embodiments the graphical display includes an indication as to the relative location of the REV with respect to the driver's vehicle. For example, the location of the REV may be plotted upon a visual map of the vehicles local vicinity and updated such that the driver can see his or her vehicle location with respect to the REV upon the map and view the relative location as it is updated over time. Such a method is generally implemented within the context of a standard vehicle navigation system.

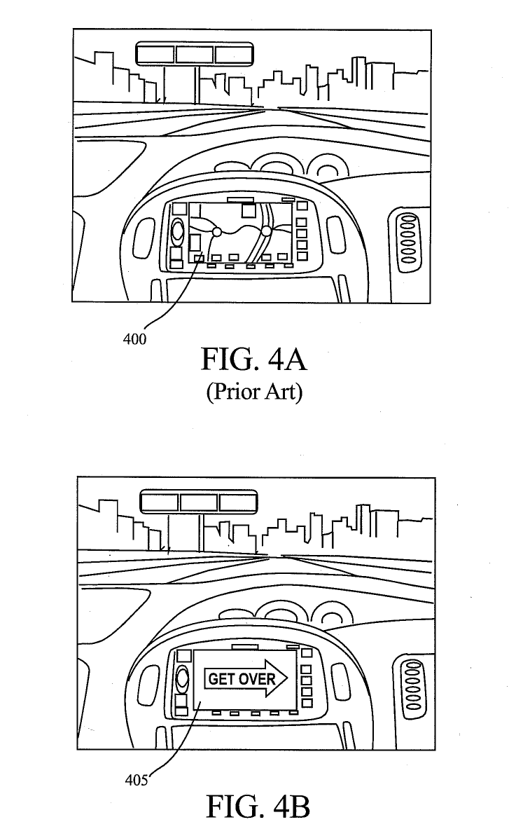

FIG. 4a illustrates a visual navigation system according to the prior art. FIG. 4a shows a ground vehicle equipped with a visual display 400 as is typically used in vehicle navigation systems. As shown, the vehicle navigation systems of the current art are often configured to display road maps to the user, the road maps positioned and/or oriented such that driver is informed of his or her location with respect to the mapped area.

As an inventive improvement to a standard vehicle navigation display, the local computing device of a ground vehicle of the present invention may also plot the location of one or more REVs upon the map display of the navigation system based upon locative data received for the one or more REVs received over a communication network. In general the system is configured only to plot the location of REVs that are within a certain proximity threshold of the ground vehicle and/or that meet certain criteria for alerting the driver as described previously. Thus for example, if an REV is within a certain proximity of the ground vehicle and upon the same road of travel, the local computing device of the present invention may be configured to alert the driver to the presence of the REV in part by plotting its location upon the vehicle navigation system map display.

In other embodiments, the REV location is not plotted upon the vehicle navigation system, but another graphical indicator is provided to alert the user as to the presence of an REV within certain proximity and/or meeting other certain factors as described previously. For example, the screen of the navigation system may be tinted an alert color (for example red or yellow or orange) when it is determined that the driver of the ground vehicle should be alerted to the presence of a nearby REV. Alternatively a warning message or symbol is displayed upon the screen of the navigation system when it is determined that the driver of a ground vehicle should be alerted to the presence of a nearby REV. Alternately a sound is displayed to the user through the speakers of the car, the sound being an alarm sound and/or siren sound and/or some other audible warming sound that is played when it is determined that the driver of the ground vehicle should be alerted to the presence of an REV. In some embodiments the sound that is previously playing from the speakers of the ground vehicle (i.e. the normal stereo sounds) are reduced in volume and/or muted when it is determined that the driver of a ground vehicle should be alerted to the presence of a nearby REV. This automatic reducing in stereo volume (and/or muting) is of particular benefit if the REV is also using its lights and sirens because it will allow the driver to better hear the distant siren of the REV.

In some such embodiments of the present invention user interface methods and apparatus are provided for lowering the volume and/or muting the stereo of a vehicle when an REV comes within certain proximity of that vehicle and/or when an REV is determined to be on the same road, traveling in the same direction, and/or is determined to possible cross paths with the vehicle at or near an intersection. In some such embodiments the adjustment of volume is performed when the REV is located behind the vehicle upon the same road of travel and ceases to be performed once the REV has passed the vehicle or moves ahead of the vehicle by some distance threshold. In some such embodiments the adjustment of volume is performed when the REV is determined to be on a possible intersecting path with the vehicle, for example at an intersection, and is not performed when it is determined that an intersecting path is not possible between the REV and the vehicle.

In some embodiments of the present invention, alternate user interface displays are used to instruct the driver of a ground vehicle to take evasive action when it is determined by the methods of the present invention that the driver should be instructed to take evasive action with respect to an REV. For example, if it is determined by the methods of the present invention that a driver of a ground vehicle should pull off to the right to allow an emergency vehicle to pass, a descriptive image, message, or symbol may be displayed to the driver to convey this instruction.

FIG. 4b illustrates a descriptive image of a navigation system according to at least one embodiment of the invention. As shown, a graphical indicator 405 is displayed upon a screen of the vehicle to the driver of the vehicle when it is determined that the driver should be instructed to pull off to the right and allow an REV to pass. In this particular embodiment, the graphical indicator 405 is a large rightward facing arrow is displayed to inform the driver of a ground vehicle is to pull to the right and allow an REV to pass. Once it is determined that the REV has passed, the indicator is removed from the screen by the local computing device of the ground vehicle. In some embodiments an audible warning is played through the speakers of the car in combination with a graphical indicator on the screen such as the one shown in FIG. 4b. In this way the presence of the audible warning may cue the user to look at the screen. The audible warning may be an audible alarm or siren sound. The audible warning may be a digitized or synthesized vocal message that is played through the speakers, for example the message “pull to the right” or “emergency vehicle needs to pass” or a both.

In some such embodiments a driver may be alerted to the presence of an REV when it comes within a first proximity of his or her vehicle and may be instructed to move to the right when it comes within a second proximity of his or her vehicle, the second proximity being neared to the vehicle than the first proximity. For example, when it is determined that the driver should be alerted to the presence of an REV based upon the REV coming within the first proximity, a sound and/or graphical indicator is displayed that informs the user of the presence of the REV and when it is determined that the driver should take evasive action based upon the REV coming within the second proximity, a specific instruction is provided to the driver such as the image shown and described with respect to FIG. 4b. In this way a driver is given initial warning about the presence of an REV and the potential need to take evasive action prior to actually being instructed to take evasive action, allowing for a safer and more controlled evasive action at the appropriate time.

In some embodiments of the present invention user interface methods and an apparatus are provided for alerting the driver of a vehicle as to the presence of an REV by playing a siren sound or other similar alert sound through the speakers of the vehicle. In some such embodiments spatial placement audio techniques are used to make the siren sound seem to the user as if it is coming from the relative direction of the REV with respect to the vehicle. In this way the audio alert provides both an indication of the presence of the REV and the relative direction of the REV with respect to the vehicle. In some such embodiments the volume of the audio alert is dependent upon the relative distance of the REV from the vehicle, i.e., the closer the distance, the louder the alert is played through the speakers. In this way the audio alert provides both an indication of the presence of the REV and the distance of the REV with respect to the vehicle. In some such embodiments the audio display is provided when the REV is located behind the vehicle upon the same road of travel and ceases to be provided once the REV has passed the vehicle or is ahead of the vehicle by some distance threshold. In some such embodiments the audio display is provided when the REV is on a possible intersecting path of the vehicle at an intersection and is not provided when an intersecting path is not possible between the REV and the vehicle.

In some embodiments of the present invention user interface methods and an apparatus are provided that display a visual indication of the relative distance between the REV and the ground vehicle. In some such embodiments the visual indication includes a numerical display of the distance between the REV and the vehicle upon a display of the ground vehicle. In some embodiments the visual indication includes a graphical meter that represents the relative distance between the REV and the vehicle. In this way the driver is informed as to how near his or her vehicle is to the REV and may respond accordingly. In some such embodiments the visual display is provided when the REV is located behind the vehicle upon the same road of travel and ceases to be provided once the REV has passed the vehicle or is ahead of the vehicle by some distance threshold. In some such embodiments the visual display is provided when the REV is on a possible intersecting path of the vehicle at an intersection and is not provided when an intersecting path is not possible between the REV and the vehicle.

In some embodiments of the present invention, alternate user interface displays are used to instruct the driver of a ground vehicle to take evasive action when it is determined by the methods of the present invention that ground vehicle and the REV may collide at an upcoming intersection. For example, if it is determined by the methods of the present invention that a driver of a ground vehicle should slow or stop and/or not enter a particular intersection that an REV may be soon to cross, a descriptive image, message, or symbol may be displayed to the driver to convey this instruction.

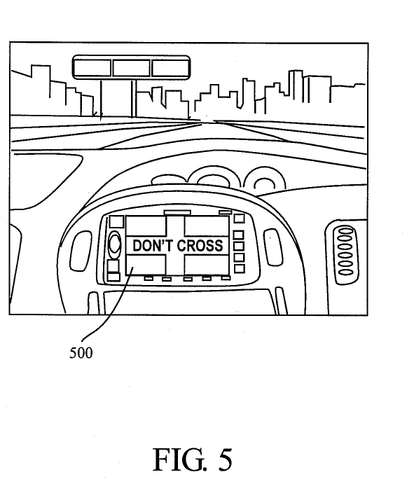

FIG. 5 illustrates a descriptive image of a vehicle navigation system provided according to at least one embodiment of the invention. As shown, a graphical indicator 500 may be displayed upon a screen of the vehicle to the driver of the vehicle when it is determined that the driver should not cross an upcoming intersection because of an approaching REV. In this particular embodiment the graphical indicator 500 is a large red drawing of a standard intersection with a message written across it that reads “DON'T CROSS,” thereby informing the driver of a ground vehicle not to cross the intersection and allow an REV to pass through. Once it is determined that the REV has passed through the intersection, the indicator is removed from the screen by the local computing device of the ground vehicle. In some embodiments an audible warning is played through the speakers of the car in combination with a graphical indicator on the screen such as the one shown in FIG. 5. In this way the presence of the audible warning may cue the user to look at the screen. The audible warning may be an audible alarm or siren sound. The audible warning may be a digitized or synthesized vocal message that is played through the speakers, for example the message “do not cross intersection” or “emergency vehicle approaching” or a both. In this way a driver may be instructed clearly that it is dangerous to cross the intersection that he or she may be approaching because of a nearby emergency vehicle.

In other embodiments of the present invention additional audio messages are accessed from memory and/or synthesized by the local computing device of a ground vehicle for display to the driver to inform the driver as to the presence of a responding emergency vehicle that either needs to pass from behind or may be a collision hazard at an intersection. For example, audio messages such as “emergency vehicle approaching from behind” and/or “emergency vehicle needs to pass” may be played to alert the user and/or inform the user to take evasive action. Similarly audio message such as “emergency vehicle approaching intersection from the left” and/or “emergency vehicle approaching intersection from the right” may be played to inform the user the approach of an emergency vehicle to an upcoming intersection from the left or right respectively. In this way a user may be informed not just that an emergency vehicle may be approaching an upcoming intersection but also may indicate to the driver which direction to expect the vehicles approach from. Such left and right approach indicators may be also or alternately displayed graphically upon a screen of the ground vehicle. Such left and right approach indicators may also be displayed as audio sounds such as simulated alarms and/or sirens through the speakers of the car, the audio sounds being displayed with spatial audio positioning techniques (sometimes referred to as 3D audio) such that the sounds are presented so they seem to the user as if they are spatially coming from the left or right depending upon the approach direction of the REV. In addition the total volume of the alert sound can be adjusted to represent the distance of the REV. Thus, as the REV approaches, the alert sounds is displayed louder to the driver of the ground vehicle, all while the left/right placement is adjusted to indicate how far to the left or right the REV is currently located. In some embodiments, this is achieved by the local computing device automatically adjusting the relative volume of the left speakers with respect to the right speakers in the vehicle to achieve the desired left/right placement of the audio alert sound. In other embodiments more complex spatial mapping audio functions are employed as is known to the art of spatially mapping audio sounds through a plurality of speakers.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. An intelligent emergency vehicle alert system comprising:
a locative server in communication with processors of each of an emergency vehicle and a ground vehicle, the locative server repeatedly receiving locative data from each of the emergency vehicle and the ground vehicle, wherein the locative data indicates a substantially current geospatial location of the respective vehicle; and
an intelligent emergency vehicle alerting process, wherein the process is operative to alert a driver of the ground vehicle of a presence of the emergency vehicle, the alert being conveyed at least in part based upon a determined spatial proximity between the emergency vehicle and the ground vehicle.

2. The intelligent emergency vehicle alert system of claim 1, wherein the locative server is a remote server connected by a wireless communication link to each of the emergency vehicle and the ground vehicle.

3. The intelligent emergency vehicle system of claim 1, wherein the locative server is located within at least one of: the emergency vehicle and the ground vehicle.

4. The intelligent emergency vehicle system of claim 1, wherein the alert is further dependent at least in part upon a determination that the emergency vehicle and the ground vehicle are traveling upon the same road of travel.

5. The intelligent emergency vehicle system of claim 1, wherein the alert is further dependent at least in part upon a determination that the emergency vehicle and the ground vehicle are traveling in the same road direction upon a common road of travel.

6. The intelligent emergency vehicle system of claim 1, wherein the alert is further dependent at least in part upon a determination that the emergency vehicle is located behind the ground vehicle, on the same road of travel.

7. The intelligent emergency vehicle system of claim 1, wherein the alert is further dependent at least in part upon a determination that the emergency vehicle and the ground vehicle are traveling upon intersecting roads of travel.

8. The intelligent emergency vehicle system of claim 1, wherein the alert is a sound alert that is output to the driver of the ground vehicle by a speaker of the ground vehicle.

9. The intelligent emergency vehicle system of claim 8, wherein the sound alert is a simulated emergency vehicle siren sound.

10. The intelligent emergency vehicle system of claim 8, wherein the sound alert is a verbal prompt indicating an evasive action to be taken by the driver.

11. The intelligent emergency vehicle system of claim 1, wherein the alert is further dependent at least in part upon a lane configuration of the road of travel of the ground vehicle.

12. The intelligent emergency vehicle system of claim 1, wherein the alert is a visual alert that is output to the driver of the ground vehicle by a screen of the ground vehicle.

13. The intelligent emergency vehicle system of claim 12, wherein the visual alert includes at least one of: a textual and a graphic indication of evasive action to be taken by the driver of the ground vehicle.

14. The intelligent emergency vehicle system of claim 12, wherein the visual alert includes an arrow indicating a direction in which the driver should pull over.

15. The intelligent emergency vehicle system of claim 12, wherein the visual alert includes an indication of a relative location of the emergency vehicle with respect to the ground vehicle.

16. The intelligent emergency vehicle system of claim 12, wherein the visual alert includes an indication of a relative distance of the emergency vehicle with respect to the ground vehicle.

17. The intelligent emergency vehicle system of claim 1, wherein the intelligent emergency vehicle alerting process is further operative to automatically reduce a volume of a stereo of the ground vehicle for a period of time.

18. An intelligent emergency vehicle alert method comprising:
providing a locative server in communication with processors of each of a emergency vehicle and a ground vehicle, wherein the locative server repeatedly receives locative data from each of the emergency vehicle and the ground vehicle, the locative data indicating the substantially current geospatial location of the respective vehicle; and
providing an intelligent emergency vehicle alerting process, wherein the process is operative to alert a driver of the ground vehicle as to the presence of the emergency vehicle, the alert being conveyed at least in part based upon a determined spatial proximity between the emergency vehicle and the ground vehicle.

19. The intelligent emergency vehicle alert method of claim 18, wherein the locative server is a remote server connected by a wireless communication link to each of the emergency vehicle and the ground vehicle.

20. The intelligent emergency vehicle method of claim 18, wherein the locative server is comprised within at least one of: the emergency vehicle and the ground vehicle.

21. The intelligent emergency vehicle method of claim 18, wherein the alert is further dependent at least in part upon a determination that the emergency vehicle and the ground vehicle are traveling upon the same road of travel.

22. The intelligent emergency vehicle system of claim 18, wherein the alert is further dependent at least in part upon a determination that the emergency vehicle and the ground vehicle are traveling in the same road direction upon a common road of travel.

23. The intelligent emergency vehicle method of claim 18, wherein the alert is further dependent at least in part upon a determination that the emergency vehicle is located behind the ground vehicle, on the same road of travel.

24. The intelligent emergency vehicle method of claim 18, wherein the alert is further dependent at least in part upon a determination that the emergency vehicle and the ground vehicle are traveling upon intersecting roads of travel.

25. The intelligent emergency vehicle method of claim 18, wherein the alert is a sound alert that is output to the driver of the ground vehicle by a speaker of the ground vehicle.

26. The intelligent emergency vehicle method of claim 18, wherein the alert is a verbal prompt indicating an evasive action to be taken by the driver.

27. The intelligent emergency vehicle method of claim 18, wherein the alert is a visual alert that is output to the driver of the ground vehicle by a screen of the ground vehicle.

28. The intelligent emergency vehicle method of claim 27, wherein the visual alert includes at least one of a textual and a graphic indication of evasive action to be taken by the driver of the ground vehicle.

29. An intelligent emergency vehicle alert method comprising:
alerting a driver of a ground vehicle as to a presence of an approaching emergency vehicle through at least one of an audio and visual display of the ground vehicle, the alert being output part based at least in part upon a determined spatial proximity between the emergency vehicle and the ground vehicle and at least one of:
a determination that the ground vehicle and the emergency vehicle are on a same road of travel,
a determination that the ground vehicle and the emergency vehicle are moving in a same road-direction of travel, and
a determination that the ground vehicle and the emergency vehicle are on intersecting roads of travel.

30. The intelligent emergency vehicle alert method of claim 29 wherein the alerting comprises attracting an attention of the driver through at least one of an audio and visual output and informing the driver as to required evasive action through at least one of an audio and visual prompt.

31. The intelligent emergency vehicle alert method of claim 29 wherein the alerting is ceased upon a determination that the emergency vehicle is no longer approaching the ground vehicle.
